(19) United States
(12) Patent Application Publication
(10) Pub. No.: US 2014/0297425 A1
(43) Pub. Date: Oct. 2, 2014

(54) APPARATUS AND METHOD FOR PROVIDING PRODUCT-RELATED INFORMATION USING COMMUNICATION SERVICE

(71) Applicants: INTIGRAM CO., LTD., Seoul (KR); INTELLECTUAL DISCOVERY CO., LTD., Seoul (KR)

(72) Inventor: Dae Hee KIM, Namyangju-si (KR)

(73) Assignees: INTIGRAM CO., LTD., Seoul (KR); INTELLECTUAL DISCOVERY CO., LTD., Seoul (KR)

(21) Appl. No.: 14/231,371

(22) Filed: Mar. 31, 2014

(30) Foreign Application Priority Data
Mar. 29, 2013 (KR) 10-2013-0034815
Mar. 29, 2013 (KR) 10-2013-0034829
Mar. 29, 2013 (KR) 10-2013-0034843

(51) Int. Cl. G06Q 30/02; G06Q 50/00

(52) U.S. Cl. CPC G06Q 30/0269; G06Q 50/01
USPC 705/14.66

(57) ABSTRACT

Provided are an apparatus and method for providing product-related information using a communication service. The method of providing product-related information using a communication service includes receiving product-related information from a terminal of a purchaser who has purchased a product, detecting information about a user who has an acquaintanceship with both the purchaser and a seller of the product by using the received product-related information, and transmitting a message for notifying the product-related information to a terminal corresponding to the detected user information.

### CROSS-REFERENCE TO RELATED APPLICATIONS

This application claims priority under 35 U.S.C. §119 to Korean Patent Application No. 10-2013-0034815, filed on Mar. 29, 2013, No. 10-2013-0034829, filed on Mar. 29, 2013, and No. 10-2013-0034843, filed on Mar. 29, 2013, the disclosure of which is incorporated herein by reference in its entirety.

### TECHNICAL FIELD

The present invention relates to an apparatus and method for providing product-related information using a communication service.

### BACKGROUND

Recently, along with the widely using of smart phones, combinations of online services and offline services have been accelerated. In particular, as convenient interface technologies, such as Near Field Communication (NFC), are being widely used in real life, the combinations will be expected to be accelerated to a level where an added value can be substantially created, for example, linkage between social network service (SNS) and offline commerce, beyond the simple provision of additional information.

However, for current smart phones, a service for providing mobile payment and a service for providing purchase information have been developed, but a service model that is combined with an offline service while still having features of SNS is in an initial development stage.

Accordingly, the effective combination between the advantages of SNS and the offline commerce may lead to revolutionary changes in a consulting business, medical profession, or service industry, which needs actual meetings and experiences, in addition to simple product electronic commerce.

In related art, communication between a company and its customer is achieved in a similar way to one-to-one conversation. That is, the communication is unilaterally performed without consideration of situations and contexts between a company and its customer.

Accordingly, the effective combination between the advantages of SNS and the offline commerce may lead to significant change in a consulting business, medical profession, or service industry, which needs actual meetings and experiences, in addition to simple product electronic commerce.

In related art, since a mileage or coupon is given to a purchaser, or a coupon is sent via the mail, the advantages of SNS and the offline commerce are not effectively combined through smart phones. However, if the advantages of SNS and the offline commerce are effectively combined, revolutionary changes may be made in a consulting business, medical profession, or service industry, which needs actual meetings and experiences, in addition to simple product electronic commerce.

### SUMMARY

Accordingly, the present invention provides an apparatus and method for providing product-related information about a product purchased by a purchaser to a user having an acquaintanceship with a product seller and a product purchaser, using a communication service.

The present invention also provides an apparatus and method for providing product-related information using a communication service that can receive the product-related information in real time from a product-related person by using a communication service.

The present invention also provides a server and method for providing benefit information to a purchaser, using a communication service, such as an instant message (IM), social network service (SNS), or messenger and provides an apparatus and method for providing more benefits to an earlier purchaser, using a communication service, such as an IM, SNS, or messenger.

In one general aspect, a method of providing product-related information using a communication service, the method includes: receiving product-related information about a product purchased by a purchaser from a terminal of the purchaser; detecting user information about a person who has an acquaintanceship with both the purchaser and a seller of the product by using the received product-related information; and transmitting a message for notifying the product-related information about the product purchased by the purchaser to a terminal corresponding to the detected user information.

In another general aspect, an apparatus for providing product-related information using a communication service, the apparatus includes: a communication unit configured to perform a communication service; a display unit configured to display a screen for a conversation performed with a conversation partner terminal by using the performed communication service; and a control unit configured to allow a terminal of a person related to the conversation about the product performed through the displayed conversation screen to participate in the conversation, control the communication unit to receive the product-related information from the participated related-person terminal, and control the display unit to display the received product-related information on the conversation screen.

In still another general aspect, an apparatus for providing product-related information using a communication service, the apparatus includes: a storage unit configured to store purchaser information about a plurality of product purchasers and purchase timing information about the plurality of product purchasers; a control unit configured to calculate purchase rankings of the plurality of product purchasers by using the purchaser information about the plurality of product purchasers and the purchase timing information about the plurality of product purchasers and generate benefit information about the plurality of product purchasers on the basis of the calculated purchase rankings of the plurality of product purchasers, and a communication unit configured to transmit the generated benefit information to the plurality of product purchasers by using a communication service, respectively.

Other features and aspects will be apparent from the following detailed description, the drawings, and the claims.

### BRIEF DESCRIPTION OF THE DRAWINGS

FIG. 1 is a conceptual view illustrating a method of providing product-related information using a communication service according to an aspect of the present invention.

FIG. 2 is a block diagram illustrating a terminal for providing product-related information using a communication service according to the present invention.

FIG. 3 is a block diagram illustrating a server for providing product-related information using a communication service according to the present invention.

FIG. 4 is an exemplary diagram showing a user information (UI) screen according to the method for providing the product-related information using a communication service according to an embodiment of the present invention.

FIG. 5 is a conceptual view illustrating an operation of an apparatus for providing the product-related information using a communication service according to another aspect of the present invention.

FIGS. 6 to 8 are exemplary diagrams showing a UI screen for allowing a product-related person of an apparatus for providing the product-related information using a communication service according to another aspect of the present invention to participate in a conversation between customers to receive the produce-related information.

FIG. 9 is a conceptual view illustrating an operation of an apparatus for providing the product-related information using a communication service according to another aspect of the present invention.

FIG. 10 is view illustrating in detail a method of providing benefit information in response to the product purchase of an apparatus for providing the product-related information using a communication service according to another aspect of the present invention.

FIG. 11 is a block diagram illustrating a server for providing the product-related information using a communication service according to the present invention.

FIG. 12 is an exemplary diagram of a computer system implementing an embodiment of the present invention.

### DETAILED DESCRIPTION OF EMBODIMENTS

The following content merely illustrates the principles of the invention. Therefore, is not clearly described or illustrated herein, although those skilled in the art, but the concept and scope of the present invention and implementation of the principles of the present invention that includes a wide variety of devices that can be invented. In addition, all conditional terms listed herein and understood that the embodiments is intended only for the purpose of, in principle, to understand the concept of the present invention is clearly not limited to the embodiment and state specifically enumerated.

In addition, the principles of perspective and an embodiment of the present invention, as well as to enumerate the specific embodiments is intended to include the structural and functional equivalents of these considerations, a detailed description of all is to be understood. In addition, these waters evenly currently known equivalents as well as equivalents will be developed in the future, i.e., to include all the elements to perform the same function, regardless of structure and invention should be understood.

Thus, for example, a block diagram of the present specification is to be understood to represent a conceptual point of view that embodies the principles of the present invention, an exemplary circuit. Similarly, flow diagrams, state transition, such as pseudo-code, understood to be substantially in a computer readable medium can be represented by a computer or processor has been clearly shown to represent the various processes are performed by a computer or processor, whether or not should be.

The processor or a similar concept that includes the functional blocks shown in the drawings and various features of the device with the ability to run the software in conjunction with the appropriate software may be provided by the use of hardware, as well as dedicated hardware. Features, a single dedicated processor, by the processor when they become available, can be provided by a single shared processor, or a plurality of individual processors, some of which can be shared.

In addition, the use of control processor, or similar terms that are presented as a concept is not to be construed quoted exclusive of hardware, with the ability to run the software, and it should be understood as implicitly including a read-only memory (ROM), a random access memory (RAM), and a nonvolatile memory for storing the digital signal processor (DSP), hardware, and software, without limitation. Also, other well-known hardware may be included. Also, other well-known hardware may be included.

Components are expressed as the means to perform the functions described in the detailed description of the claims herein, including all types of software, for example, which includes a combination of circuit elements that perform the functions or the firmware/microcode intended to include, and how to perform the function of, for performing the functions mentioned above are combined with appropriate circuitry for executing software. Equal the present invention is defined by the scope of these claims, because a combination of the features offered by various means listed and combined with the claim needs to be understood by any means that can provide the functions herein.

The aforementioned objects, features and advantages will become more apparent through the following detailed description with respect to the accompanying drawings, the technical idea of the present invention with a person of ordinary skill in the art the present invention, accordingly, can be easily carried out. In describing the present invention, a detailed description of known techniques associated with the present invention unnecessarily obscure the gist of the present invention, it is determined that the detailed description thereof will be omitted.

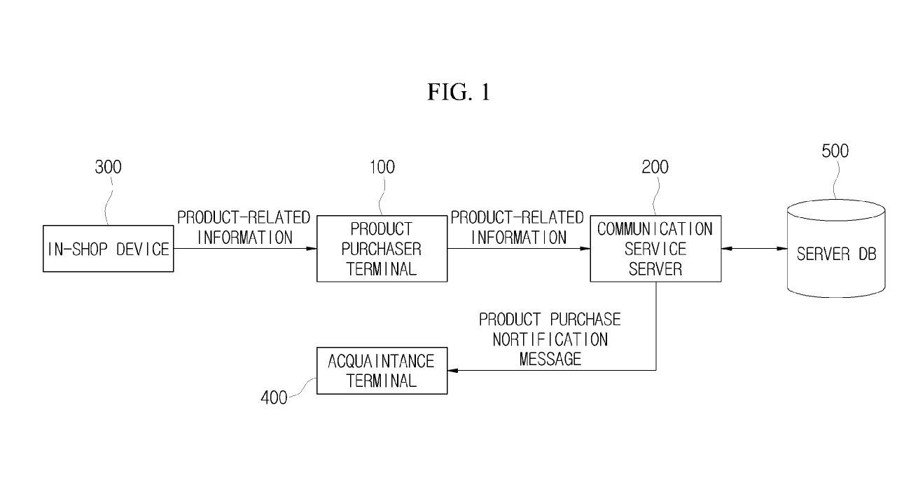

FIG. 1 is a conceptual view illustrating a method of providing product-related information using a communication service according to an aspect of the present invention.

The method of providing product-related information using a communication service according to an aspect of the present invention includes receiving product-related information from a terminal of a purchaser who has purchased a product, detecting information about a user who has an acquaintanceship with both the purchaser and a seller of the product by using the received product-related information, and transmitting a message for notifying the product-related information to a terminal corresponding to the detected user information.

Referring to FIG. 1, a purchaser desiring to purchase a specific product may purchase the specific product by making payment for the specific product through a short-range access by a product purchaser terminal 100 to an in-shop device 300. Here, the short-range access means that the product purchase terminal 100 access the in-shop device 300 within a predetermined distance in order to perform a short-range wireless communication with the in-shop device 300. Preferably, the short-range wireless communication may be Near Field Communication (NFC). NFC is a non-contact short-range wireless communication standard using a frequency band of 13.56 MHz, which may transmit or receive data when a plurality of devices are in a short distance from each other, for example, about 10 cm.

However, the short-range wireless communication is not limited thereto, but may include a barcode scheme, a QR code scheme, Bluetooth, and so on.

When an operation about purchase of the specific product is performed through the short-range access between the in-shop device 300 and the product purchase terminal 100, the in-shop device 300 may transmit product-related information about a product purchased using the product purchaser terminal 100. Here, ‘product-related information’ may include seller information and product information (for example, information for product description, such as a price, product image, model number, or the like). Furthermore, if necessary, the product-related information may further include purchaser information about a purchaser who has purchased a specific product.

Here, transmission of the product-related information may be performed using a short-range wireless communication, such as NFC.

However, the transmission of the product-related information is not limited thereto, but may be performed over a local area network (LAN), mobile communication network such as 3G or 4G, or WiFi network while payment be made using the short-range wireless communication, such as NFC.

When the product purchaser terminal 100 receives the product-related information, a communication service application such as an IM, SNS, messenger, or the like, which is installed in the product purchaser terminal 100, may transmit the received product-related information to a communication service server 200. Here, transmission of the product-related information may be transmitted when a transmission command is input from a user, or transmitted automatically.

As an example, when the purchaser information is not included in the product-purchase information, the product purchaser terminal 100 may transmit the product-related information having the purchaser information, which is used to identify the product purchaser terminal 100, added thereto to the communication service server 200.

Here, the transmission may be performed over a local area network (LAN) or Internet network, a mobile communication network such as 3G or 4G, or WiFi network.

In this case, the communication service server 200 may detect the purchaser information and the seller information from the received product-related information. In addition, the communication service server 200 may detect information about acquaintances of the purchaser from a server database (DB) using the detected purchaser information. Then, the communication service server 200 may detect information about a user having an acquaintanceship with both the product seller and the product purchaser from the server DB by using the detected acquaintanceship information and seller information. For example, if a user ‘C’ is an acquaintance of both a purchaser ‘A’ and a seller ‘B’, the communication service server 200 may detect information about the user ‘C’ who has an acquaintance with both the product seller ‘B’ and the product purchaser ‘A’. Here, the server DB 200 may be implemented in the server 200 or may be implemented as a separate DB that is connected with the communication service server 200.

The communication server 200 may transmit a message for notifying the product-related information about the product purchaser to a terminal 400 of a person who has an acquaintanceship with both the product seller and the product purchaser. Here, the message may be provided as a URL, which is an address where the product-related information, such as seller information and product information, for the product purchaser is located, or provided as a text, image, video, or the like.

The product purchaser terminal 100 and the acquaintance terminal 400 may be implemented with various devices such as a smart phone, a tablet computer, a notebook, a personal digital assistant (PDA), a portable multimedia player (PMP), etc.

According to an embodiment of the present invention, it is possible to provide product-related information about a product purchased by the product purchaser to a user having an acquaintanceship with both the product purchaser and the product seller using a communication service, such as IM, SNS, etc., thereby allowing the product-related information to be utilized as not a spam message but useful information. It is also possible to facilitate the sale of the product of the product seller while publicizing the product purchaser.

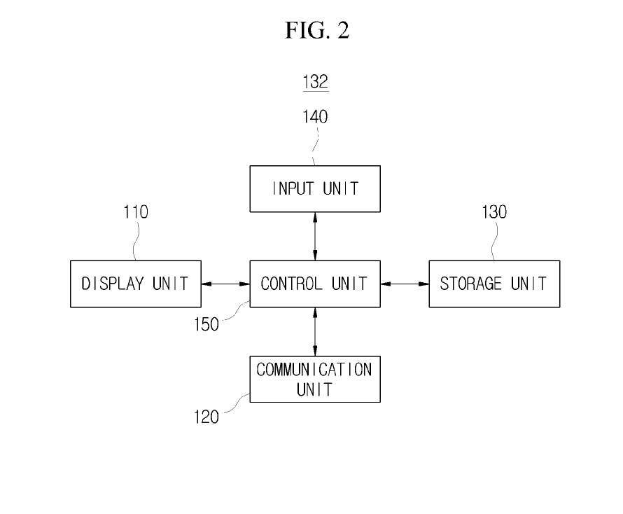

FIG. 2 is a block diagram illustrating a terminal for providing product-related information using a communication service according to the present invention. Referring to FIG. 2, the product purchaser terminal 100 includes some or all of a display unit 110, a communication unit 120, a storage unit 130, an input unit 140, and a control unit 150. The product purchaser terminal 100 may be implemented in a variety of devices, such as a smart phone, a tablet computer, a notebook, a personal digital assistant (PDA), a portable multimedia player (PMP), a navigation device, a digital TV, etc. Preferably, the product purchaser terminal 100 may be a product purchaser terminal.

The display unit 110 may function to display a screen and implemented using at least one of a liquid crystal display, a thin film transistor-liquid crystal display, an organic light-emitting diode, a flexible display, a 3D display, and a transparent display.

The communication unit 120 allows communication between the product purchaser terminal 100 and an external device. In particular, when the short-range access is performed between the product purchaser terminal 100 and the in-shop device 300, the communication unit 120 may perform payment for the purchased product using a short-range wireless communication.

In addition, the communication unit 120 may received the product-related information from the in-shop device 300. Here, the communication unit 120 enables wired or wireless connection over a Local Area Network (LAN) and an Internet network, through a universal serial bus (USB) port, over a mobile communication network such as 3G and 4G, and by a short-distance communication such as Near Field Communication (NFC), Radio Frequency Identification (RFID), and Wi-Fi.

The storage unit 130 functions to store various data and programs needed for an operation of the product purchaser terminal 100. Here, the storage unit 130 may be implemented as an embedded storage device such as a random access memory (RAM), a flash memory, a read only memory (ROM), an erasable programmable ROM (EPROM), an electronically erasable and programmable ROM (EEPROM), a register, a removable disk, and a memory card, or a removable storage device such as a USB memory and a CD-ROM.

The input unit 140 receives a user input for manipulating the product purchaser terminal 100. Here, the input unit 140 may be implemented using at least one of a variety of buttons, a touch sensor for receiving a touch input on the display unit 110, a proximity sensor for receiving a motion that is not in contact with but in close proximity to a surface of the display unit 110, and a microphone for receiving a voice input from a user. However, the input unit 140 is not limited thereto, but may be implemented in any form as long as the user input can be received.

The control unit 150 controls the overall operation of the product purchaser terminal 100. Specifically, the control unit 150 may control some or all of the display unit 110, the communication unit 120, the storage unit 130, and the input unit 140.

In particular, when the product-related information is received from the in-shop device 300 through the communication unit 120, the control unit may process and store the received product-related information to the storage unit 130. As an example, when the purchaser information is not included in the product-purchase information, the product purchaser terminal 100 may generate and store the product-related information having the purchaser information, which is used to identify the product purchaser terminal 100, added thereto to the storage unit 130.

In addition, the control unit 150 may control the communication unit 120 to transmit the processed product-related information to the communication service server 200, such as an IM, SNS, or messenger, using the installed communication service application.

Here, the control unit 150 may include a CPU, a ROM configured to store a control program, and a RAM configured to store an input data or used as a task-related memory region. Here, the CPU, the ROM, and the RAM may be connected with each other through an internal bus.

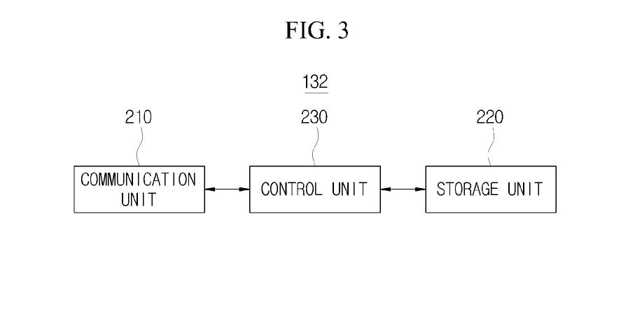

FIG. 3 is a block diagram illustrating a server for providing product-related information using a communication service according to the present invention. Referring to FIG. 3, the communication service server 200 includes some or all of a communication unit 210, a storage unit 220, and a control unit 230.

The communication unit 210 allows communication between the product purchaser terminal 200 and an external device. In particular, the communication service server 200 may receive the product-related information from the product purchaser terminal 100 through the communication unit 210.

The storage unit 220 functions to store various data and programs needed for an operation of the communication service server 200. In particular, the storage unit 220 may store acquaintanceship information about a plurality of users registered with an IM, SNS, or messenger.

The control unit 230 controls the overall operation of the communication service server 200. Specifically, the control unit 210 may control some or all of the communication unit 210 and the storage unit 220.

In particular, the control unit 230 may detect the purchaser information and the seller information from the received product-related information. In addition, the control unit 230 may detect information about an acquaintance of the purchaser using the detected purchase information and the acquaintanceship information stored in the storage unit 220. In addition, the control unit 230 may detect information about an acquaintance of the seller using the detected seller information and the acquaintanceship information stored in the storage unit 220. Moreover, the control unit 230 may detect information about an acquaintance of both the product purchaser and the product seller by using the seller acquaintance information and purchaser acquaintance information.

In addition, the control unit 230 may control the communication unit 210 to transmit a message for notifying the product-related information for the product purchaser to a terminal 400 of the acquaintance having an acquaintanceship with both the product purchaser and the product seller by using a communication service. Here, the message may be provided as a URL, which is an address where the product-related information, such as seller information and product information, for the product purchaser is located, or provided as a text, image, video, or the like.

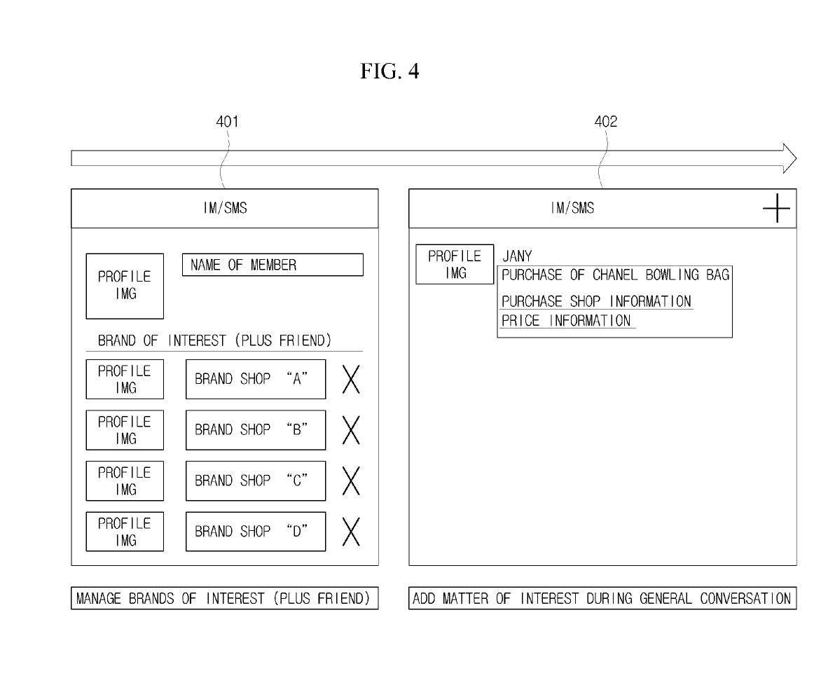

FIG. 4 is an exemplary diagram showing a user information (UI) screen according to the method for providing the product-related information using a communication service according to an embodiment of the present invention. Referring to FIG. 4, the product purchaser terminal 100 or the acquaintance terminal 400 may add, as a friend, a specific brand to a brand of interest through a communication service application (see 401 of FIG. 4). In this case, the brand of interest added as a friend may be updated in the acquaintanceship information stored in the storage unit 220 of the communication service server 200.

In addition, the acquaintance terminal 400, which is a terminal of an acquaintance having an acquaintanceship with both the product seller and the product purchaser, may receive a message for notifying the product-related information about the product purchaser from the communication service server 200, and display the received message (see 402 of FIG. 4). Here, the message may be provided as a URL indicating an address where the product-related information for the product purchaser (for example, seller information (purchase shop information) and product information (price information)) are located. Thus, when a user of the acquaintance terminal 400 selects the information, the acquaintance terminal 400 may move to a corresponding address to display a web page. However, the product-related information is not limited thereto, but may be provided as a text, image, and video and directly displayed in a communication service screen.

The methods according to various embodiments of the present invention may be implemented by program codes, and provided to individual servers or devices as being stored in a non-transitory computer readable medium.

The non-transitory computer readable medium means a medium for semi-permanently storing data, which is readable by the device, not a medium for storing data for a short time, such as a register, a cache, a memory, etc. Specifically, the above-described various applications or programs may be provided as being stored in a non-transitory computer readable medium such as a CD, a DVD, a hard disk, a Blu-lay disc, a USB, a memory card, a ROM, etc.

An apparatus for providing product-related information using a communication service according to another aspect of the present invention includes a communication unit configured to perform the communication service, a display unit configured to display a screen for a conversation performed with a conversation partner terminal by using the performed communication service, and a control unit configured to allow a terminal of a person related to the conversation about the product performed through the displayed conversation screen to participate in the conversation, control the communication unit to receive the product-related information from the participated related-person terminal, and control the display unit to display the received product-related information on the conversation screen.

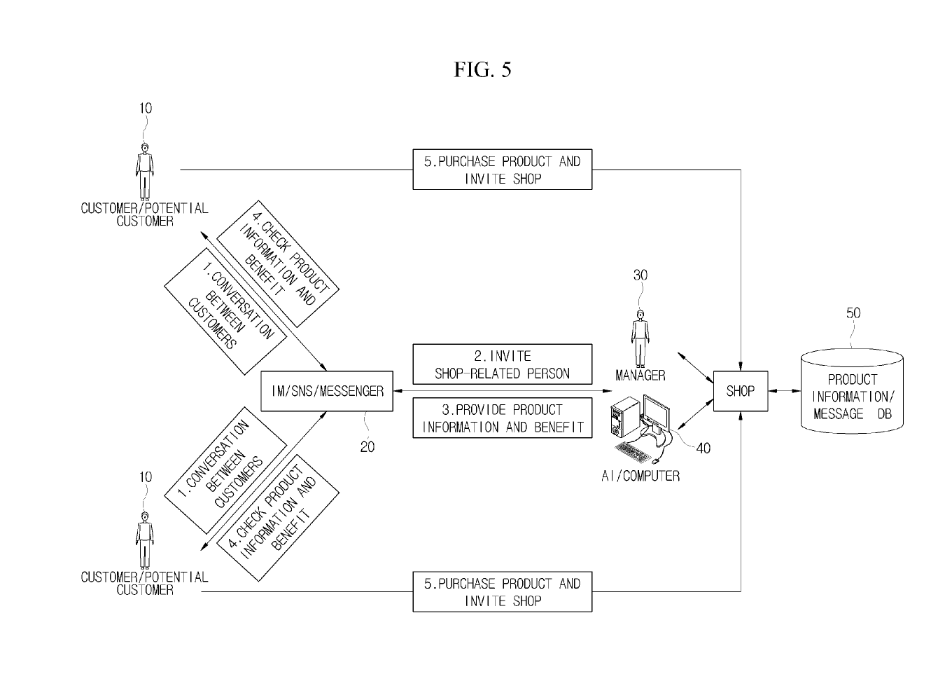

FIG. 5 is a conceptual view illustrating an operation of an apparatus for providing the product-related information using a communication service according to another aspect of the present invention.

Referring to FIG. 5, each of customers 10 may perform conversation using a communication server 20 such as an IM, SNS, or messenger in its own terminal. As an example, in order to purchase a specific product, the customers 10 may have a conversation about the specific product.

In addition, the person related to a topic of the conversation, manager 30 may be allowed to participate in the conversation performed between the customers 10.

As an example, at least one of the customers 10 who have participated in the conversation directly may search a list of friends for a person related to the topic of the conversation 30 and invite the searched person, thereby allowing the person associated with the conversation topic to participate in the conversation.

As another example, before or during the conversation, the customer terminal may receive selection of the conversation topic, and in this case, a person associated with the selected conversation topic 30 may be allowed to participate in the conversation. Specifically, the customer terminal may transmit data about the selected conversation topic (for example, data for identifying that the selected conversation topic is “sneakers” if ‘sneakers” is selected as the conversation topic) to the communication service server. In this case, the communication service server may detect information (for example, identification information, such as a MAC address, of a related-person device) about a related person who is matched with the data about the received conversation topic. In addition, the communication service server may transmit a signal for requesting participation in the conversation to the related-person terminal corresponding to the detected related-person information. In this case, when a person related to the topic of the conversation approves the participation request, the related person may be allowed to participate in the conversation performed between the customers.

The above-described request signal may include information about conversation performed between the customers 10 before the participation of the related person 30. Thus the related person 30 may check the conversation performed between the customers 10 before the participation.

Here, the conversation of the related person 30 who has participated in the conversation may be performed using a terminal of the related person 40. As an example, the conversation may be performed using a variety of devices capable of performing a communication service, such as a smart phone, a tablet computer, a notebook, a personal digital assistant (PDA), a portable multimedia player (PMP), a navigation device, a digital TV, etc.

Furthermore, the related person who has participated in the conversation may provide the product-related information during the conversation. Here, the product-related information may include product information (for example, for sneakers “A,” size: 280 mm, price: x won, stock: 2, photo, etc.) and product benefit information (for example, a discount coupon), and the related-person terminal 40 may store the provided product-related information therein.

Here, the product-related information may be manually provided by the related-person 30 inputting a message during the conversation. Alternatively, if the related-person terminal has an artificial intelligence (AI) function, the related-person terminal 40 may extract a keyword from the conversation between the customers, analyze the product-related information, and automatically provide the product-related information.

Furthermore, the customers may check the product-related information provided during the conversation. A terminal of each customer may store the received product-related information therein.

The customer may visit an offline or online shop of the related person to purchase the product on the basis of the product-related information.

Here, the related-person terminal 40 may store the product-related information provided to the customer 10 in a product information/message database 50 in order to provide the product-related information later and provide a product benefit upon purchase of the product.

Furthermore, the customer terminal may store the product-related information therein using the product-related information provided from the related person upon the purchase of the product.

According to an embodiment of the present invention, it is possible to receive the product-related information in real time by using a communication service, such as an IM, SMS, or the like, thereby facilitating customer satisfaction and product sale.

FIG. 2 is a block diagram illustrating a terminal for providing product-related information using a communication service according to the present invention. Referring to FIG. 2, the product purchaser terminal 100 includes some or all of a display unit 110, a communication unit 120, a storage unit 130, an input unit 140, and a control unit 150. Here, product purchaser terminal 100 may be implemented in a variety of devices capable of performing a communication service, such as a smart phone, a tablet computer, a notebook, a personal digital assistant (PDA), a portable multimedia player (PMP), a navigation device, a digital TV, etc. Preferably, the product purchaser terminal 100 may be a customer terminal.

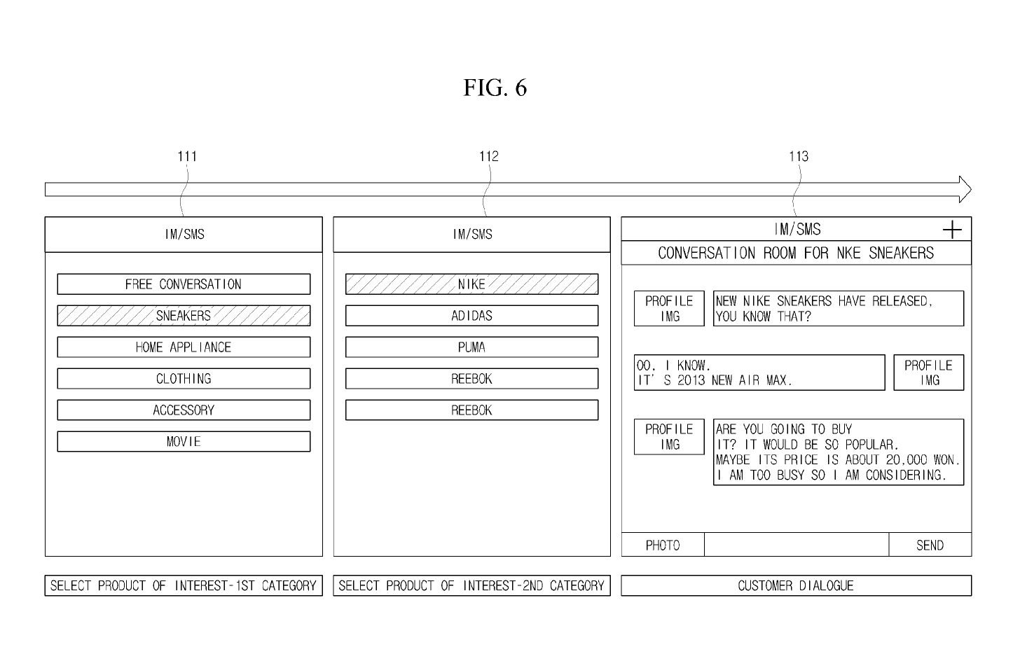

The display unit 110 functions to display a screen. In particular, the display unit 110 may display a screen associated with the communication service, as shown in FIGS. 6 to 8.

Here, the display unit 110 may be implemented using at least one of a liquid crystal display, a thin film transistor-liquid crystal display, an organic light-emitting diode, a flexible display, a 3D display, and a transparent display.

The communication unit 120 allows communication between the product purchaser terminal 100 and an external device. Here, the communication unit 120 enables wired or wireless connection over a Local Area Network (LAN) and an Internet network, through a universal serial bus (USB) port, over a mobile communication network such as 3G and 4G, and by a short-distance communication such as Near Field Communication (NFC), Radio Frequency Identification (RFID), and Wi-Fi.

The storage unit 130 functions to store various data and programs needed for an operation of the product purchaser terminal 100. Here, the storage unit 130 may be implemented as an embedded storage device such as a random access memory (RAM), a flash memory, a read only memory (ROM), an erasable programmable ROM (EPROM), an electronically erasable and programmable ROM (EEPROM), a register, a removable disk, and a memory card, or a removable storage device such as a USB memory and a CD-ROM.

The input unit 140 receives a user input for manipulating the product purchaser terminal 100. Here, the input unit 140 may be implemented using at least one of a variety of buttons, a touch sensor for receiving a touch input on the display unit 110, a proximity sensor for receiving a motion that is not in contact with but in close proximity to a surface of the display unit 110, and a microphone for receiving a voice input from a user. However, the input unit 140 is not limited thereto, but may be implemented in any form as long as the user input can be received.

The control unit 150 controls the overall operation of the product purchaser terminal 100. Specifically, the control unit 150 may control some or all of the display unit 110, the communication unit 120, the storage unit 130, and the input unit 140.

In particular, the control unit 150 may control conversation performed using a communication service such as an IM, SNS, or messenger. As an example, the control unit 150 may control the display unit 110 to display a screen for the conversation performed using the communication service.

In addition, the control unit 150 may allow the person related to a topic of the conversation to participate in the conversation performed between the customers. As an example, the display unit 110 may display a list of friends including the person related to the topic of the conversation. When the related person is selected on the displayed screen, the control unit 150 may allow the selected related person to participate in the conversation.

As another example, the display unit 110 may display a screen for receiving selection of a topic of a conversation before or during the conversation. The control unit 150 may control the communication unit 120 to transmit data about the selected conversation topic (for example, data for identifying that the selected conversation topic is “sneakers” if ‘sneakers” is selected as the conversation topic) to the communication service server. In this case, the related person may be allowed to participate in the conversation under the control of the above-described communication server.

In addition, when the product-related information is received from the related person who has participated in the conversation, the control unit may control the display unit to display the received product-related information on the conversation screen and control the storage unit 130 to store the received product-related information.

Here, the control unit 150 may include a CPU, a ROM configured to store a control program, and a RAM configured to store an input data or used as a task-related memory region. Here, the CPU, the ROM, and the RAM may be connected with each other through an internal bus.

FIGS. 6 to 8 are exemplary diagrams showing a UI screen for allowing a product-related person of an apparatus for providing the product-related information using a communication service according to another aspect of the present invention to participate in a conversation between customers to receive the produce-related information.

Referring to FIGS. 6 to 8, the product purchaser terminal 100 may display screens 111 and 112 for receiving selection of a topic of a conversation having at least one hierarchy structure before the conversation is initiated. As an example, the product purchaser terminal 100 may display a screen including menu items of free conversation, sneakers, home appliance, clothing, movie, etc. and when “sneakers” is selected, may display a screen including menu items of Nike, Adidas, Puma, Reebok, etc. (112)

When the conversation topic is selected on the screen, the product purchaser terminal 100 may display a screen for performing a conversation with the customer terminal.

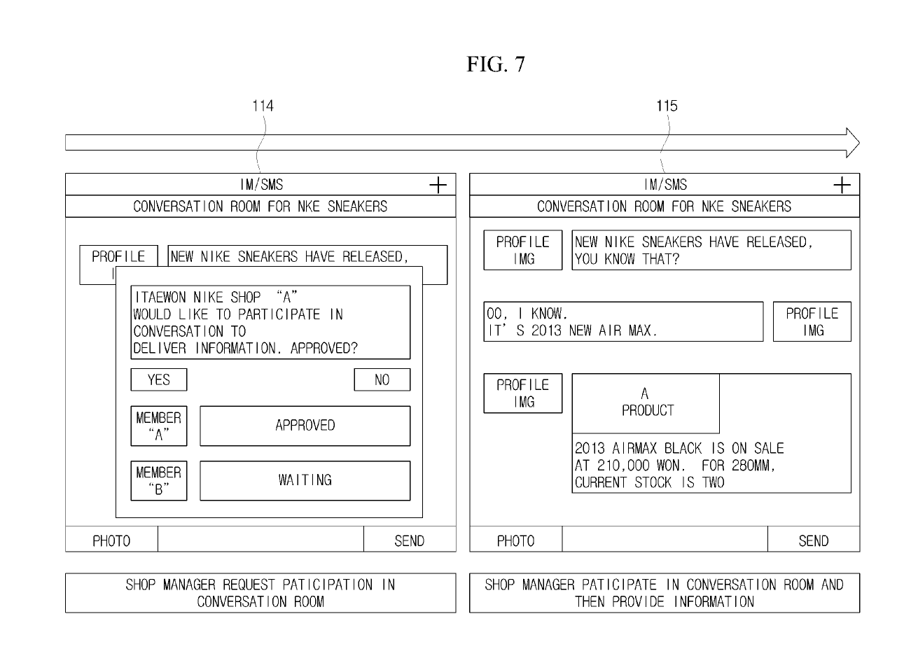

In addition, the product purchaser terminal 100 may transmit data about the selected conversation topic (for example, data for identifying that the selected conversation topic is “sneakers, Nike” if “sneakers, Nike” are selected as the conversation topic) to the communication service server. The product-related person (for example, a manager of Nike shop “A” in Itaewon, South Korea) may request participation in a conversation between the customers, under the control of the above-described communication service server as shown in FIG. 7.

If the participation of the product-related person in the conversation is approved by the customers, the product-related person may provide the product-related information. In this case, the product-related information 115-1 may be displayed in a conversation window 115.

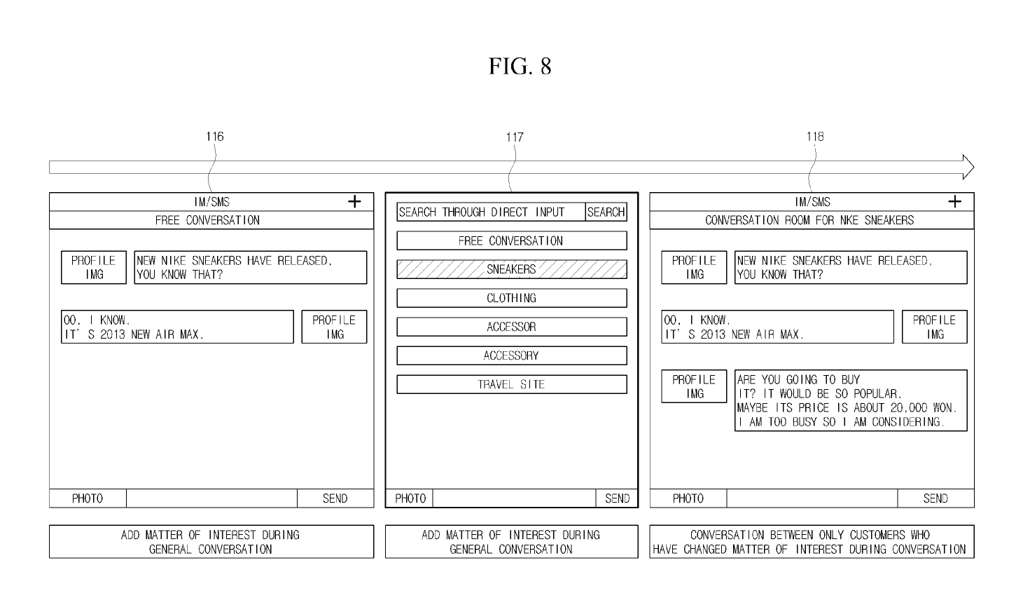

The selection of the conversation topic may be performed before the conversation, as shown in FIG. 6 or if necessary, performed during the conversation as shown in 117 of FIG. 8.

The methods according to various embodiments of the present invention may be implemented by program codes, and provided to individual servers or devices as being stored in a non-transitory computer readable medium.

The non-transitory computer readable medium means a medium for semi-permanently storing data, which is readable by the device, not a medium for storing data for a short time, such as a register, a cache, a memory, etc. Specifically, the above-described various applications or programs may be provided as being stored in a non-transitory computer readable medium such as a CD, a DVD, a hard disk, a Blu-lay disc, a USB, a memory card, a ROM, etc.

An apparatus for providing the product-related information using the communication service according to another aspect of the present invention includes a storage unit configured to store purchaser information about a plurality of product purchasers and purchase timing information about the plurality of product purchasers, a control unit configured to calculate purchase rankings of the plurality of product purchasers by using the purchaser information about the plurality of product purchasers and the purchase timing information about the plurality of product purchasers and generate benefit information about the plurality of product purchasers on the basis of the calculated purchase rankings of the plurality of product purchasers, and a communication unit configured to transmit the generated benefit information to the plurality of product purchasers by using a communication service, respectively.

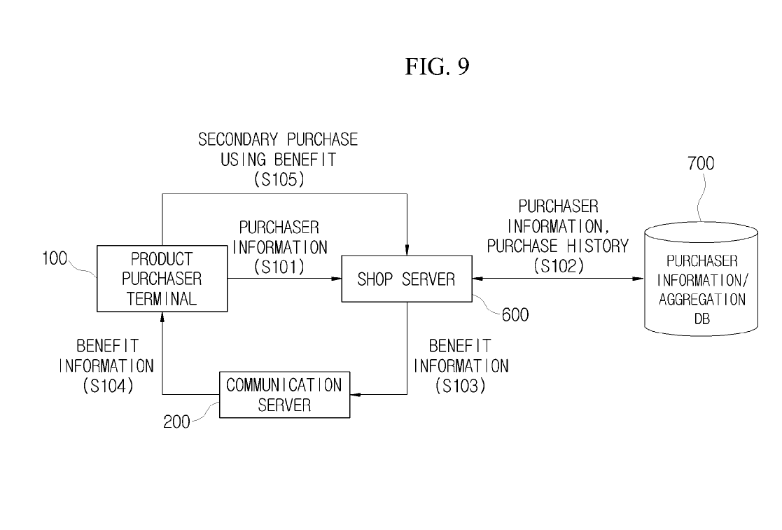

FIG. 9 is a conceptual view illustrating an operation of an apparatus for providing the product-related information using a communication service according to another aspect of the present invention.

Referring to FIG. 9, a customer who purchased or will purchase a product of a specific shop (hereinafter, referred to as a purchaser) may provide purchaser information to the shop server 600 through the product purchaser terminal 100 in operation S101. As an example, the purchaser may access a webpage provided by the shop by using the product purchaser terminal 100 and enter the purchaser information into a member subscription screen provided in the accessed webpage to provide the purchase information to the shop server 600. Alternatively, the purchaser may execute a communication service application such as an IM, SNS, or messenger that is installed in the product purchaser terminal 100 and make a friend with the specific shop to provide the purchaser information to the shop server 600.

Here, the product purchaser terminal 100 may be implemented in a variety of devices capable of performing a communication service, such as a smart phone, a tablet computer, a notebook, a personal digital assistant (PDA), a portable multimedia player (PMP), a navigation device, a digital TV, etc.

In addition, the purchaser information may be information, such as an instant message (IM) ID, an SNS ID, and a messenger ID, for identifying a purchaser in a variety of communication services.

According to operation S101, the purchaser may be registered, as a new member, with the specific shop which has provided the purchaser information.

When the purchaser information is provided to the shop server 600, the shop server 600 may store the purchaser information to a purchaser information aggregation DB 700. Here, the purchaser information aggregation DB 700 may store the purchaser information about a plurality of purchasers registered as members with the shop server 600, purchase history information about a product purchased by each of the plurality of purchasers, etc. Thus, the shop server 600 may request and receive the purchaser information, the purchase history information, etc. from the purchaser information aggregation DB in operation S102. Here, the purchaser information aggregation server DB 700 may be implemented in the shop server 600 or may be implemented as a separate DB that is connected with the shop server 600.

The shop server 600 may analyze purchase patterns of the plurality of purchasers by using the received purchaser information and purchase history information. As an example, the shop server 600 may analyze a purchase pattern of that a purchaser having a communication service ID of “A” has a lot of interest in “sneakers” and a purchaser having a communication service ID of “B” has a lot of interest in “shoes” by using the received purchaser information and purchase history information.

Furthermore, the shop server 600 may generate the benefit information corresponding to the purchase patterns of the plurality of purchasers by using the analyzed purchase patterns. As an example, the shop server may generate a discount coupon associated with ‘sneakers’ for the purchaser having a communication service ID of “A” and generate a discount coupon associated with ‘shoes’ for the purchaser having a communication service ID of “B.”

Alternatively, the shop server 600 may analyze purchase rankings of a plurality of purchasers with respect to a specific product by using the received purchaser information and purchase history information. As an example, the shop server 600 may analyze that a purchaser having a communication service ID of “A” thinks about the purchase ranking for sneakers “A” as being the highest, a purchaser having a communication service ID of “B” or “C” thinks about the purchase ranking for sneakers “A” as being the second-highest, and a purchaser having a communication service ID of “D,” “E,” or “F” thinks about the purchase ranking for sneakers “A” as being the third-highest.

Furthermore, the shop server 600 may generate the benefit information corresponding to the purchase rankings of the plurality of purchasers by using the analyzed purchase rankings. That is, the shop server may generate the benefit information in order to distribute more benefit information to an earlier purchaser on the basis of the purchaser rankings of the plurality of purchasers determined at the end of a benefit information distribution period, which is a timing at which the benefit information is provided to the purchaser. As an example, distribution of the benefit information according to the purchase rankings may be performed by generating a mileage coupon using a weight given in proportion to a value obtained by dividing cumulative sales up to a mileage coupon distribution period by cumulative sales up to a purchase timing. That is, if it is assumed that 10% of total sales are provided as a mileage coupon, the purchaser having a communication service ID of “A” may be provided with a mileage coupon corresponding to 6/9 of 10% of total sales, the purchaser having a communication service ID of “B” or “C” may be provided with a mileage coupon corresponding to 2/9 of 10% of total sales, and the purchaser having a communication service ID of “D,” “E,” or “F” may be provided with a mileage coupon corresponding to 1/9 of 10% of total sales. Thus, more benefits are provided to earlier purchaser, thereby inducing publicity of the purchaser and preventing a person desiring to purchase a product from delaying the purchase. However, the above-described mileage coupon generating method is only an example, and various mileage coupon generating methods may be applied.

In addition, the shop server 600 may transmit a message corresponding to the generated benefit information to the product purchaser terminal 100 corresponding to the purchaser information by using a communication service, such as an IM, SNS, or messenger.

Here, the shop server 600 may generate and transmit the above-described benefit information to the product purchaser terminal 100 whenever a product is purchased by the purchaser or when a certain number or more of products are purchased.

The purchaser may check the benefit information corresponding to the benefit information received through the product purchaser terminal 100. Here, the message corresponding to the benefit information may be provided as a URL or as a text, image, video, or the like.

In addition, the purchaser may utilize the message corresponding to the benefit information stored in the product purchaser terminal 100 when the purchaser visits the shop later to purchase a product. Here, a purchase history of the secondary purchase of the purchaser may be stored in the purchaser information aggregation DB, and the above-described operation of providing the benefit information may be repeated to provide another benefit for the purchaser.

According to an embodiment of the present invention, the benefit information provided from the shop server to the purchaser may cause the secondary purchase behavior of the purchaser to be facilitated through a communication service, such as an IM, SMS, or the like, thereby facilitating the product sale.

In addition, more benefits are provided to earlier purchaser, thereby inducing publicity of the purchaser and preventing a person desiring to purchase a product from delaying the purchase.

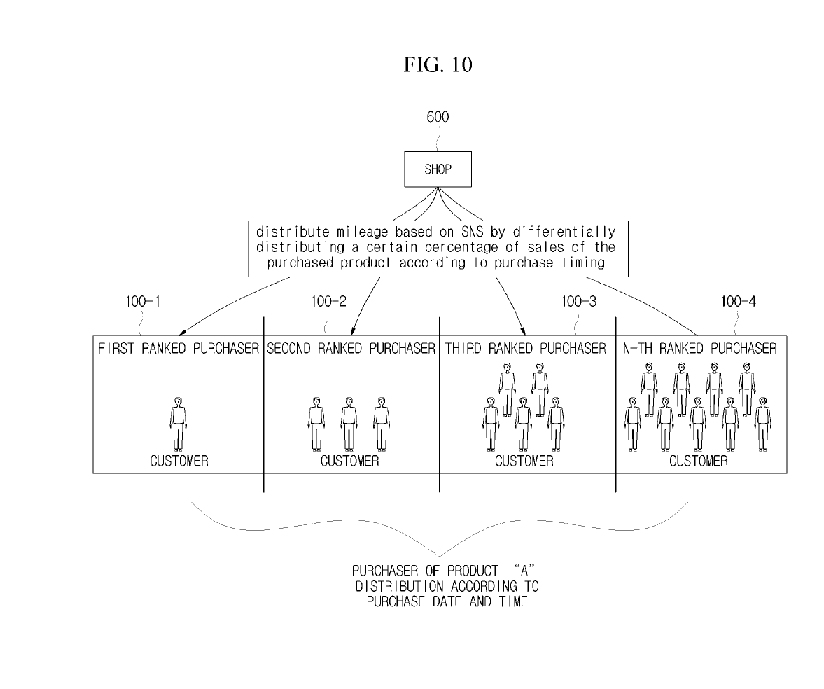

FIG. 10 is view illustrating in detail a method of providing benefit information in response to the product purchase of an apparatus for providing the product-related information using a communication service according to another aspect of the present invention. Referring to FIG. 10, the shop server 600 may analyze purchase rankings of a plurality of purchasers with respect to a specific product using the received purchaser information and purchase history information. Furthermore, the shop server 600 may generate the benefit information corresponding to the purchase rankings of the plurality of purchasers by using the analyzed purchase rankings. That is, the shop server may generate the benefit information in order to distribute more benefit information to an earlier purchaser on the basis of the purchaser rankings of the plurality of purchasers determined at the end of a benefit information distribution period, which is a timing at which the benefit information is provided to the purchaser. Thus, the shop server 600 may differentially provide mileage coupons through a communication service such as an IM, SNS, or messenger, according to purchase rankings such as a first ranked purchaser 100-1, a second ranked purchaser 100-2, a third ranked purchaser 100-3, . . . , a n-th ranked purchaser 100-N.

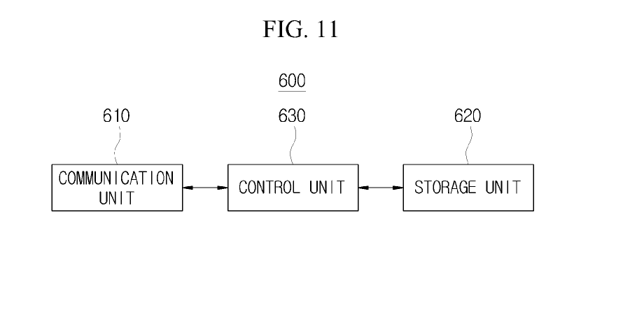

FIG. 11 is a block diagram illustrating a shop server for providing product-related information using a communication service according to another aspect of the present invention. Referring to FIG. 11, the shop server 600 may include some or all of a communication unit 610, a storage unit 620, and a control unit 630.

The communication unit 610 allows communication between the server 600 and an external device. In particular, the shop server 600 may receive purchaser information about a purchaser through the communication unit 610.

In addition, the shop server 600 may transmit the benefit information generated through the communication unit 610, to the communication service server 200. In this case, the benefit information transmitted to the communication service server 200 may be transmitted, as a message, to a corresponding product purchaser terminal 100 by using a communication service such as an IM, SNS, or messenger.

Here, the communication unit 120 enables wired or wireless connection over a Local Area Network (LAN) and an Internet network, through a universal serial bus (USB) port, over a mobile communication network such as 3G and 4G, and by a short-distance communication such as Near Field Communication (NFC), Radio Frequency Identification (RFID), and Wi-Fi.

The storage unit 620 functions to store various data and programs needed for an operation of the server 600. Here, the storage unit 620 may store the purchaser information about a plurality of purchasers registered as members with the shop server 600, purchase history information about a product purchased by each of the plurality of purchasers, etc.

Here, the storage unit 620 may be implemented as an embedded storage device such as a random access memory (RAM), a flash memory, a read only memory (ROM), an erasable programmable ROM (EPROM), an electronically erasable and programmable ROM (EEPROM), a register, a removable disk, and a memory card, or a removable storage device such as a USB memory and a CD-ROM.

The control unit 630 controls the overall operation of the shop server 600. Specifically, the control unit 610 may control some or all of the communication unit 610 and the storage unit 620.

In particular, the control unit 630 may request and receive the purchaser information, the purchase history information, etc. from the purchaser information aggregation DB.

In addition, the control unit 630 may analyze purchase patterns of the plurality of purchasers by using the received purchaser information and purchase history information. Furthermore, the control unit 630 may generate the benefit information corresponding to the purchase patterns of the plurality of purchasers by using the analyzed purchase patterns.

Alternatively, the control unit 630 may analyze purchase rankings of a plurality of purchasers with respect to a specific product using the received purchaser information and purchase history information. Furthermore, the control unit 630 may generate the benefit information corresponding to the purchase rankings of the plurality of purchasers by using the analyzed purchase rankings.

In addition, the control unit 630 may control the communication unit 610 to transmit a message corresponding to the generated benefit information to the product purchaser terminal 100 corresponding to the purchaser information by using a communication service, such as an IM, SNS, or messenger.

Here, the control unit 630 may include a CPU, a ROM configured to store a control program, and a RAM configured to store an input data or used as a task-related memory region. Here, the CPU, the ROM, and the RAM may be connected with each other through an internal bus.

According to various embodiments of the present invention, it is possible to provide product-related information about a product purchased by the product purchaser to a user having an acquaintanceship with the product seller and the product purchaser using a communication service, such as IM, SNS, etc., thereby allowing the product-related information to be utilized as not a spam message but useful information, and facilitating the sale of the product of the product seller while publicizing the product purchaser.

It is also possible to receive the product-related information in real time from the product-related person by using a communication service, such as an IM, SMS, or the like, thereby facilitating customer satisfaction and product sale.

The benefit information provided from a server to a purchaser may cause a secondary purchase behavior of the purchaser to be facilitated, thereby facilitating the product sale. And also, an earlier purchaser receiving more benefits may induce publicity of the purchaser and prevent a person desiring to purchase a product from delaying the purchase.

The effect of the present invention is not limited to the aforesaid, but other effects not described herein will be clearly understood by those skilled in the art from descriptions below.

The methods according to various embodiments of the present invention may be implemented by program codes, and provided to individual servers or devices as being stored in a non-transitory computer readable medium.

The non-transitory computer readable medium means a medium for semi-permanently storing data, which is readable by the device, not a medium for storing data for a short time, such as a register, a cache, a memory, etc. Specifically, the above-described various applications or programs may be provided as being stored in a non-transitory computer readable medium such as a CD, a DVD, a hard disk, a Blu-lay disc, a USB, a memory card, a ROM, etc.

While this invention has been particularly shown and described with reference to preferred embodiments thereof, it will be understood by those skilled in the art that various changes in form and details may be made therein without departing from the spirit and scope of the invention as defined by the appended claims, and also the various changes should not be understood departing from the spirit and scope of the invention.

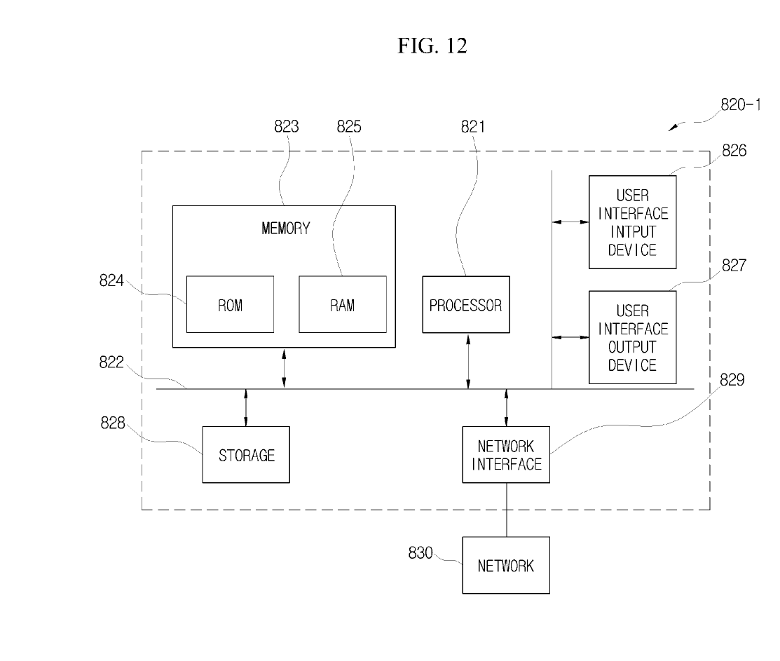

An embodiment of the present invention may be implemented in a computer system, e.g., as a computer readable medium. As shown in in FIG. 12, a computer system 820-1 may include one or more of a processor 821, a memory 823, a user input device 826, a user output device 827, and a storage 828, each of which communicates through a bus 822. The computer system 820-1 may also include a network interface 829 that is coupled to a network. The processor 821 may be a central processing unit (CPU) or a semiconductor device that executes processing instructions stored in the memory 823 and/or the storage 828. The memory 823 and the storage 828 may include various forms of volatile or non-volatile storage media. For example, the memory may include a read-only memory (ROM) 824 and a random access memory (RAM) 825.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

What is claimed is:

1. A method of providing product-related information using a communication service, the method comprising:
receiving product-related information about a product purchased by a purchaser from a terminal of the purchaser;
detecting user information about a person who has an acquaintanceship with both the purchaser and a seller of the product by using the received product-related information; and
transmitting a message for notifying the product-related information about the product purchased by the purchaser to a terminal corresponding to the detected user information.

2. The method of claim 1, wherein the receiving of product-related information comprises: performing payment for the purchased product through a short-range access to a payment device having a payment function, receiving the product-related information about the purchased product from the payment device, and receiving the product-related information from a terminal of the purchaser, the terminal transmitting the product-related information received from the payment device.

3. The method of claim 2, wherein the receiving of product-related information comprises receiving the product-related information including purchaser information about the purchased product, seller information about the purchased product, and product information about the purchased product.

4. The method of claim 2, further comprising comparing the received product-related information with acquaintanceship information stored in a server.

5. An apparatus for providing product-related information using a communication service, the apparatus comprising:
a communication unit configured to perform the communication service;
a display unit configured to display a screen for a conversation performed with a conversation partner terminal by using the performed communication service; and
a control unit configured to allow a terminal of a person related to the conversation about the product performed through the displayed conversation screen to participate in the conversation, control the communication unit to receive the product-related information from the participated related-person terminal, and control the display unit to display the received product-related information on the conversation screen.

6. The apparatus of claim 5, wherein the display unit display a screen for receiving selection of one of topics of the conversation performed with the conversation partner terminal.

7. The apparatus of claim 6, wherein a topic is selected from among the topics displayed by the display unit, the control unit transmits data for allowing a terminal of a person related to the selected conversation topic to participate in the conversation to a server for the communication service.

8. The apparatus of claim 5, wherein the communication unit receives the product-related information including product information or product benefit information.

9. An apparatus for providing product-related information using a communication service, the apparatus comprising:
a storage unit configured to store purchaser information about a plurality of product purchasers and purchase timing information about the plurality of product purchasers;
a control unit configured to calculate purchase rankings of the plurality of product purchasers by using the purchaser information about the plurality of product purchasers and the purchase timing information about the plurality of product purchasers and generate benefit information about the plurality of product purchasers on the basis of the calculated purchase rankings of the plurality of product purchasers; and
a communication unit configured to transmit the generated benefit information to the plurality of product purchasers by using a communication service, respectively.

10. The apparatus of claim 9, wherein the control unit generates the benefit information in order to distribute more benefit information to an earlier purchaser on the basis of the purchaser rankings of the plurality of purchasers determined at the end of a benefit information distribution period, the benefit information distribution period being a timing at which the benefit information is provided to the purchaser.

11. The apparatus of claim 10, wherein the control unit generates the benefit information using a weight given in proportion to a value obtained by dividing cumulative sales up to a mileage coupon distribution period by cumulative sales up to a purchase timing.
